(19) United States
(12) Patent Application Publication
(10) Pub. No.: US 2005/0052181 A1
(43) Pub. Date: Mar. 10, 2005

(54) Method and apparatus for magnetic field measurement

(76) Inventors: Simon Lam, West Lindfield New South Wales (AU); David Louis Tilbrook, Glenore (AU)

Correspondence Address: KENYON & KENYON, 1500 K STREET, N.W., SUITE 700, WASHINGTON, DC, 20005, US

(21) Appl. No.: 10/479,253

(22) PCT Filed: May 31, 2002
(86) PCT No.: PCT/AU02/00696

(30) Foreign Application Priority Data
Jun. 1, 2001 (AU) PR 5396

(51) Int. Cl. G01N 27/82

(52) U.S. Cl. 324/242

(57) ABSTRACT

The invention provides for measurement of an actual magnitude of an applied magnetic field, rather than providing a value of magnetic field which is relative to an unknown quiescent value. In particular, by providing a SQUID (100) having an effective area which varies in response to applied flux, an absolute value of magnetic field can be determined due to the change in effective area of the SQUID (100).

### TECHNICAL FIELD

The present invention relates to magnetic field measurement and in particular provides a superconducting method and apparatus for magnetic field measurement.

### BACKGROUND ART

Superconducting Quantum Interference Devices (SQUIDs) are often used as highly sensitive magnetic field sensors. Such SQUID sensors are becoming increasingly popular due to the capabilities of high sensitivity sensing in areas such as geophysical mineral prospecting and biological magnetic field detection, such as magnetic field emanations from the human brain.

With the advent of high critical temperature superconducting (HTS) materials such as YBa₂Cu₃Oₓ (YBCO), HTS-SQUIDs can be cooled by relatively inexpensive liquid nitrogen, and can be made in a compact form.

The HTS radio frequency (rf) SQUID is essentially a superconducting ring made of YBCO or the like, the ring being interrupted by a Josephson Junction or weak link. When the superconducting ring is energised by an inductively coupled resonant rf-oscillator, tunnelling of electrons takes place at the junction and a periodic signal, being a function of flux through the ring, can be detected across the junction. The periodic signal is substantially a triangular waveform, usually having a period (ΔB) in the order of a nanotesla. Therefore, in order to yield a sensitivity in the femtotesla range, the SQUID is operated in a nulling bridge mode, or flux locked loop (FLL) mode. In this mode, magnetic flux is fed back to the SQUID so as to cause the output voltage to remain relatively constant. The feedback voltage, being proportional to the difference between the applied flux and the quiescent flux level, gives a highly accurate measurement of relative magnetic flux. The feedback voltage V can therefore be written as
V=M(A_{eff}B+u) (1)
where
M is a constant in a specific SQUID system;
A_{eff} is the effective area of the SQUID;
B is the applied magnetic field; and
u is the quiescent flux.

However, since the quiescent flux u is unknown, SQUIDs provide only relative measurements of magnetic field, and do not provide a measurement of an absolute magnitude of magnetic field. Further, when the applied flux changes too quickly, at a rate which is greater than the “slew rate” of the SQUID, the loop loses lock, and a discontinuous output results. Due to the periodic nature of the SQUID response, it is not possible to determine from the output whether the SQUID has regained lock at a same position in the periodic waveform, and thus such interrupted results are of limited use.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Throughout this specification, the terms ‘superconducting material’, ‘superconducting device’ and the like are used to refer to a material or device which, in a certain state and at a certain temperature, is capable of exhibiting superconductivity. The use of such terms does not imply that the material or device exhibits superconductivity in all states or at all temperatures.

### SUMMARY OF THE INVENTION

According to a first aspect the present invention resides in a method of measurement of absolute magnitude of a magnetic field, the method comprising the steps of:
providing a superconducting quantum interference device having an effective flux-collection area which varies with applied flux; and
determining an absolute magnitude of an applied magnetic field based on variations in said effective area.

According to a second aspect, the present invention provides a superconducting quantum interference device for measurement of absolute magnitude of a magnetic field, the device having an effective flux-collection area which varies with applied flux.

It has been realised that periodicity of the output voltage function of a SQUID relies on the effective area of the SQUID. Accordingly, providing a SQUID with an effective area which alters or varies at one or more known absolute values of flux density, enables the SQUID to detect when the one or more known flux densities are applied, due to the changing periodicity of the output voltage of the SQUID at those flux densities. Hence, absolute magnetic field values may be measured by the SQUID.

Further, the absolute value of an applied flux which is different to the one or more known absolute values of flux may be determined with reference to the one or more known flux densities. Accordingly, the method and device of the present invention allow measurement of the absolute value of an applied field to be measured, at least when the strength of that field is in the vicinity of the one or more known flux values to allow comparison to the one or more known flux values.

It has further been realised that Provision of a flux-dam in the pick-up loop of a SQUID is an effective manner in which to provide a SQUID having an effective area which varies with applied flux. In such embodiments, the flux-dam ‘opens’ and ‘closes’, depending on whether the circulating current in the pick-up loop is greater than or less than the critical current of the flux-dam. That is, the flux-dam becomes resistive when the circulating current in the pick-up loop exceeds the critical current of the flux-dam. As the circulating current is caused by applied flux, there exists a critical (and calculable) value of applied magnetic field at which the flux-dam becomes resistive. At that point, the flux-dam becomes resistive, causing the effective area of the SQUID to change, and so the periodicity of the output voltage of the SQUID changes, enabling the absolute value of the applied magnetic field to be measured. The absolute value of an applied magnetic field of different magnitude to the critical magnetic field may be determined by reference to the critical magnetic field.

Accordingly, in a third aspect the present invention resides in a method of measurement of absolute value of a magnetic field, the method comprising the steps of:
providing a pick-up loop for a SQUID, the pick-up loop having a flux dam having a critical current, the critical current occurring in the pick-up loop when a critical magnetic field is applied to the SQUID; and
determining an absolute value of an applied magnetic field by comparison to said critical magnetic field.

The method of the third aspect of the present invention may further comprise the step of fabricating the flux-dam such that the critical magnetic field is in a magnetic field range of interest.

According to a fourth aspect, the present invention resides in a pick-up loop for a SQUID for measurement of absolute value of a magnetic field, the pick-up loop having a flux dam having a critical current, the critical current arising when a critical magnetic field is applied to the SQUID, and the flux dam being formed such that the critical magnetic field is in a magnetic field range of interest.

The SQUID may comprise a superconducting ring of HTS material, such as YBCO, interrupted by a Josephson Junction. The Josephson Junction may be implemented by formation of a grain boundary in the HTS material, for example by forming the junction over a step-edge in a substrate. The step edge could, for example, be formed in accordance with the teachings of International Patent Publication No. WO 00/16414, the contents of which are incorporated herein by reference. Of course, the Josephson Junction may be formed in a different manner, for example by use of a microbridge, an ion-irradiated link, a superconductor-insulator-superconductor (SIS) junction, a superconductor-normal metal-superconductor (SNS) junction or the like.

Similarly, where a flux-dam is used to provide an effective area dependent on flux, the flux dam may be implemented by forming a grain boundary at a step edge in a substrate, or by use of a microbridge, or the like.

Further, it will be appreciated that the present invention is applicable to both rf-SQUIDs and dc-SQUIDs.

### BRIEF DESCRIPTION OF THE DRAWINGS

By way of example only, preferred embodiments of the invention are described with reference to the accompanying drawings, in which:

FIG. 1 illustrates a schematic block diagram of a flux-locked loop suitable for operating a high-T_{c} rf SQUID;

FIG. 2a is a graph which illustrates the variation of the amplitude of the rf voltage across the tuned circuit as a function of the magnetic flux in the SQUID chip;

FIGS. 2b and 2c illustrate quiescent magnetic field conditions and departures therefrom;

FIGS. 3a and 3b depict the rf oscillation and envelope;

FIG. 4 illustrates a dc-SQUID flux-locked loop;

FIG. 5 is a schematic drawing of an rf SQUID with a pick-up loop having a flux dam;

FIG. 6 is a plot of pickup loop enclosed flux against the applied flux; and

FIG. 7 is a plot of the open loop SQUID output voltage and the applied magnetic field against time, illustrating the change in output voltage periodicity with changing field.

### DESCRIPTION OF THE INVENTION

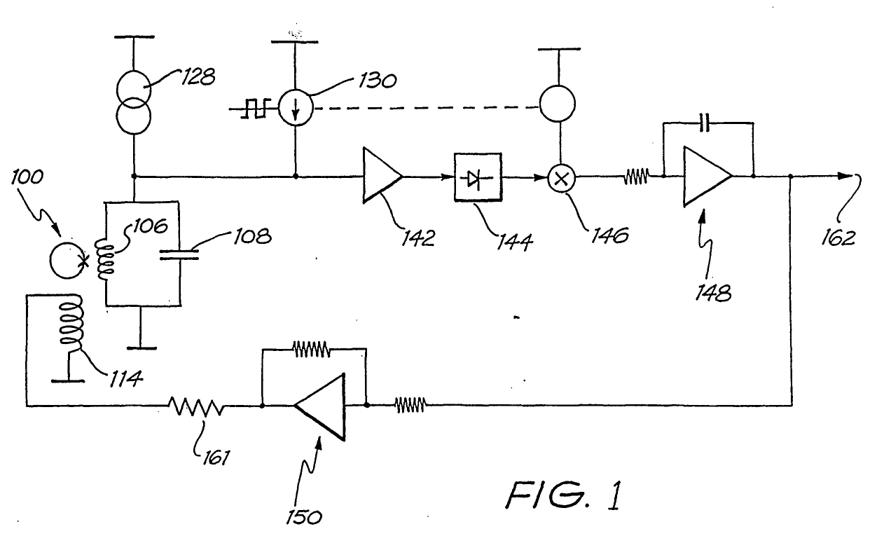

FIG. 1 illustrates a schematic block diagram of a flux-locked loop suitable for operating a high-T_{c} rf SQUID 100. Radio frequency current source 128 provides a sinusoidal current to drive the tuned circuit comprising rf coil 106 in parallel with capacitor 108. Typically, the rf current has a frequency ranging from 1 MHz to microwave frequencies, but preferably the frequency is in the range of 150 MHz to 200 MHz. The field from rf coil 106 is coupled to high-T_{c} SQUID chip 100, and the amplitude of the rf voltage generated across the tuned circuit is affected by the magnetic flux in the SQUID 100.

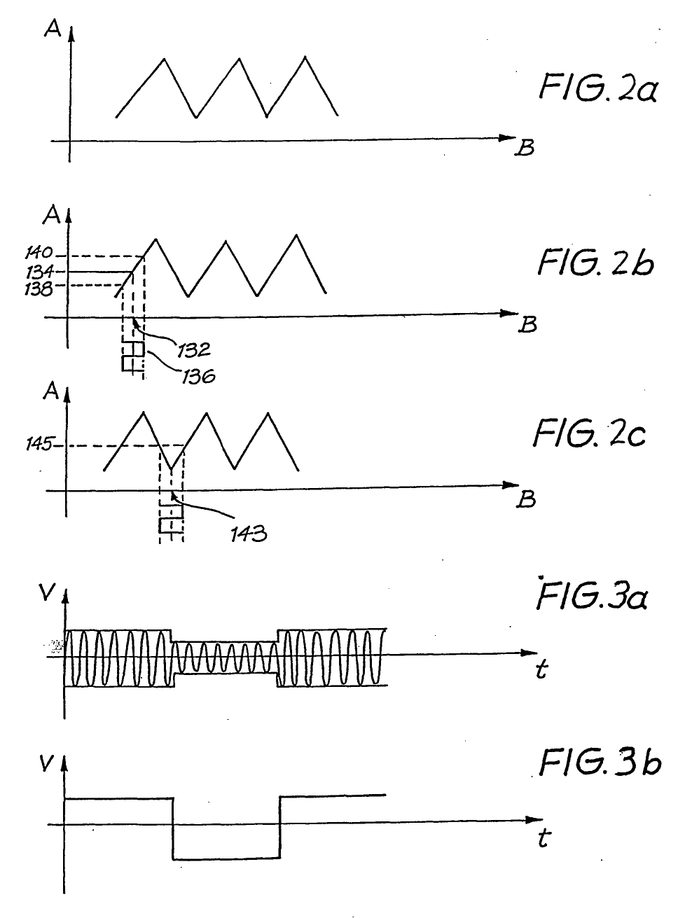

FIG. 2a is a graph which illustrates the variation of the amplitude of the rf voltage across the tuned circuit 106, 108 as a function of the magnetic flux in the SQUID chip 100. The amplitude is substantially a periodic, triangular-wave function of the magnetic flux.

Current source 130 superimposes a square-wave onto the sinusoidal current from source 128. Typically, the superimposed square-wave current has a longer period than the sinusoidal current. Preferably, the period of the square-wave current is of the order of ten microseconds. The effect of the square-wave current is to alter the magnetic flux density in the SQUID chip 100. As shown in FIG. 2b, the magnetic flux density to be measured sets up a quiescent magnetic flux density 132 in the SQUID chip, and this results in quiescent amplitude 134 of the rf voltage.

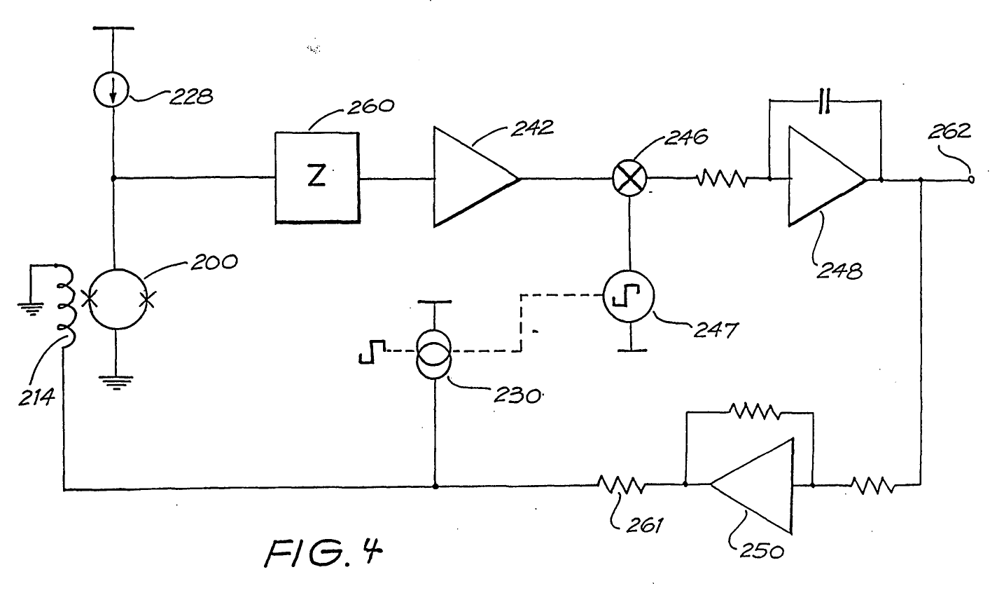

If the quiescent flux density is such that the amplitude of the rf voltage is not at a maximum or minimum, as illustrated in FIG. 2b, the superimposed square wave flux oscillations 136 cause the amplitude of the rf voltage to oscillate between levels 138 and 140. A typical waveform of the resulting rf voltage is shown in FIG. 3a. Alternatively, when the quiescent flux density in the SQUID chip is such that the amplitude of the rf voltage is at a maximum or a minimum, as illustrated by flux density 143 in FIG. 2c, the amplitude of the resulting rf voltage is constant at level 145.

The rf voltage across the tuned circuit is amplified by amplifier 142, and its amplitude is detected by diode detector 144. The output of the diode detector consists substantially of the square-wave envelope of the signal at the input of amplifier 142, as shown in FIG. 8b. If the flux density is not at a minimum of the triangular waveform but, for example, is at level 132 as shown in FIG. 2b, the amplitude of the detected waveform is proportional to the difference between levels 140 and 138. Alternatively, if the quiescent flux level coincides with a maximum or a minimum in the triangular amplitude versus flux density characteristic, as illustrated by flux density 142 of FIG. 2c, the amplitude of the detected waveform will be approximately zero.

If the quiescent flux density is in a region in which the characteristic has a positive slope, level 140 will be higher than level 138. In contrast, if the quiescent flux density is in a region in which the characteristic has a negative slope, level 140 will be lower than level 138. Thus, the phase of the detected waveform relative to the square-wave current depends on the slope of the voltage versus flux characteristic at the quiescent level.

Multiplier 146 multiplies the detected voltage by a voltage which is in phase with the square-wave current of source 130 to produce a product voltage which varies according to the quiescent flux level and the phase of the detected voltage. The product voltage is zero if the quiescent flux level coincides with a minimum or a maximum of the amplitude versus flux characteristic, is at a maximum positive level if the quiescent flux level is in the centre of a positively-sloped section of the amplitude versus flux characteristic, and is at a maximum negative level if the quiescent flux level is in the centre of a negatively-sloped section of the amplitude versus flux characteristic.

The product voltage is integrated by integrator 148, amplified by variable gain amplifier 150, and the resulting signal is used to energise feedback coil 114 via resistor 161 to subject SQUID chip 100 to a feedback magnetic flux density.

The effect of the negative feedback is to apply a second magnetic flux density to the SQUID chip such that the total magnetic flux density is substantially constant. The output voltage of integrator 148 is, therefore, indicative of the difference between the magnetic flux density to be measured and the substantially constant magnetic flux density. Therefore, it can be seen that the device shown in FIG. 1 does not measure absolute value of magnetic field, but only a difference in magnetic flux density.

As shown in FIG. 2c, which illustrates the amplitude versus flux relationship in the flux-locked loop in equilibrium, the effect of the feedback is to drive the flux threading the SQUID to a constant value. The maximum rf amplitude corresponds to an unstable equilibrium point in the flux-locked loop, and deviation from this point will result in the loop converging to a minimum rf voltage.

Referring to FIG. 4, a dc SQUID flux-locked loop (FLL) is illustrated. There are many variations and refinements possible but this is a typical basic circuit. Much of it is similar to the rf SQUID flux-locked loop described with reference to FIG. 1 and the operation can be explained with reference to FIGS. 2 and 3b (but excluding 3a).

The current source 228 provides dc current bias for the SQUID 200. When correctly biased, the SQUID output voltage is a periodic function of magnetic flux in the SQUID (FIG. 2a). A square wave (or possibly sinusoidal) current source 230, of typical frequency 100 kHz, provides flux modulation to the SQUID via coil 214. The SQUID output voltage (waveform 3b) is modulated at the same frequency as the flux with an amplitude and sign which depends on the quiescent magnetic flux in the SQUID. On a peak (FIG. 2c) the amplitude is zero. The SQUID output signal is usually passed through an impedance matching circuit 260 (eg. a transformer or tuned circuit) to optimise signal/noise ratio, then an amplifier 242 and demodulator (eg. multiplier) 246 driven by a signal source 247 synchronous with the modulation of the current source 230. The output of the demodulator is a dc or slowly varying signal whose amplitude is proportional to the amplitude of the modulated signal from the SQUID. Negative output corresponds to a SQUID flux for which the slope of the voltage-flux characteristic (FIG. 2a) is negative, and conversely for positive output. The FLL is completed by signal conditioning circuits which may include an integrator 248 and amplifier 250 whose output produces a low-frequency current in the coil 214 via feedback resistor 261. The sense of the feedback is negative, ie., a positive applied flux produces a negative feedback flux, and vice versa, the net result being to lock the circuit onto a peak of the SQUID voltage-flux characteristic (FIG. 2c). The circuit output voltage 262 is proportional to the applied flux in the SQUID which is, in the case of a SQUID magnetometer, proportional to the relative applied magnetic field.

Again, it can be seen that the dc-SQUID measures only a relative value of magnetic field and not an absolute magnetic field value.

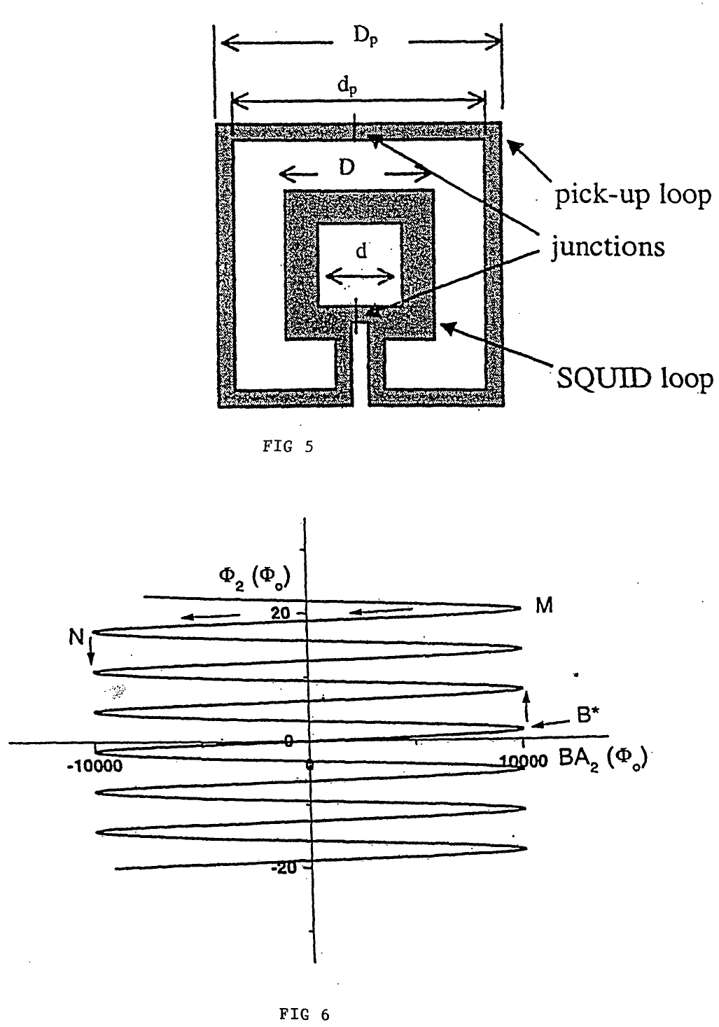

Turning now to FIG. 5, a rf-SQUID is shown, having a SQUID loop with area A₁, internal dimension d and external dimension D and with a Josephson Junction formed over a localised step edge in the substrate. A pick-up loop is also provided, having an area A₂, internal dimension dₚ and external dimension Dₚ, and having a flux dam formed over a second localised step edge in the substrate.

It has been found that, when magnetic field applied perpendicular to the SQUID is swept through a range of magnitudes, the periodicity of the output voltage changes to a different value at a certain field magnitude, denoted B*. The change of periodicity is due to the change of the effective area caused by the flux dam, and so it is possible to modulate the SQUID's effective area by opening and closing the flux dam. Such a scheme raises the possibility of measuring the exact field value in an unknown field environment.

We now turn in more detail to study the effects of magnetic flux on the rf SQUIDs with a flux dam in the pick-up loop, and the calculation of the effective areas when the flux dam opens and closes.

FIG. 5 shows the geometry of a rf SQUID where a magnetic field B is applied perpendicular to the plane of the SQUID. Assuming that the pick-up loop area A₂ is much larger than the SQUID loop area A₁, and ignoring the contribution of the magnetic field which spills into the SQUID loop due to current flowing in the pick-up loop, one obtains the following relations for the SQUID loop and the pick-up loop:
Φ₁=BA₁−L₁I₁+L₁I₂ (2)
Φ₂=BA₂−L₂I₂ (3)
where Φ, A, L and I are the flux, area, inductance and circulating current of the pick-up loop (denote 2) and SQUID (denote 1) respectively.

As there is a junction (flux dam) in the pick-up loop (see FIG. 5), the current I₂ behaves as I₂=I_{c2} sin(2πΦ₂/Φ₀) where Φ₀ is the flux quantum and I_{c2} is the maximum value of I₂. Thus, equation (3) can be re-written as:
Φ₂=BA₂−L₂I_{c2} sin(2πΦ₂/Φ₀). (4)

Table 1 (following) illustrates device values for three embodiments of the invention. The values of L₂ of these devices is ≅10 nH and I_{c2} is about 0.8 mA. Therefore, L₂I_{c2}≅10000Φ₀. FIG. 6 shows a plot of equation (4) with L₂I_{c2}≅10000Φ₀. We define B* as the field at which I₂=I_{c2}. As L₂I_{c2}>>Φ₀, Φ₂<<BA₂ for B<B* (see FIG. 6) and thus B*≅L₂I_{c2}/A₂. After substituting equation (3) into equation (2), we obtain:
Φ₁+L₁I₁=BA₁+(BA₂−Φ₂)L₁/L₂ (5)
and using Φ₂<<BA₂ for B<B*, we get:
Φ₁+L₁I₁=B(A₁+A₂L₁/L₂). (6)

Therefore, the SQUID plus the pick-up loop has an effective area A₁+A₂L₁/L₂ (Table I).

At B=B*, I₂=I_{c2} and the flux dam junction becomes resistive which allows vortices to move into the pick-up loop. This corresponds to a vertical jump along the vertical axis Φ₂ at B* (FIG. 6) and a reduction in I₂ slightly below I_{c2}. As B increases further, I₂ increases until it reaches I_{c2} again and another jump occurs. When B≧B*, the maximum screening flux due to I₂ is Φₘ≅L₂I_{c2}≅B*A₂ and hence, Φ₂≅(BA₂−B*A₂). Equation (5) thus becomes:
Φ₁+L₁I₁−L₁A₂B*/L₂=BA₁ (7)

which means the effective area of the device is ≅A₁. The pick-up loop has a maximum circulating current of I_{c2} which induces a flux L₁A₂B*/L₂ into the SQUID hole. Table I tabulates the calculated values of A₁+A₂L₁/L₂ and A₁ of the devices studied herein.

TABLE I

| Devices | 1 | 2 | 3 |
|---|---|---|---|
| Dₚ (mm) | 3.4 | 4.4 | 8.0 |
| dₚ (mm) | 2.4 | 3.4 | 7.0 |
| A₂ (mm²) | 8.4 | 15.0 | 56.3 |
| L₂ (nH) | 4.7 | 7.18 | 17.5 |
| A₁ (mm²) | 0.150 | 0.150 | 0.150 |
| A_{eff} (mm²) (B ≧ B*) | 0.168 | 0.170 | 0.162 |
| A₁ + A₂L₁/L₂ (mm²) | 0.418 | 0.463 | 0.630 |
| A_{eff} (mm²) (B < B*) | 0.248 | 0.310 | 0.455 |
| B* (mT) | 1.86 | 0.96 | 1.28 |
| Iₑ (mA) | 0.82 | 0.59 | 1.33 |

Measured and calculated properties of rf SQUIDs with different geometrical dimensions. All three devices have the same values of D=2 mm and d=100 μm which gives L₁≅150 pH.

Three devices were fabricated with the same values of D and d but with different Dₚ and dₚ values (Table I). The flux dam junctions in all devices consisted of a step-edge junction 20 μm wide and ≅200 nm thick. The SQUID was coupled to a tank circuit. The open loop output voltage of the tank circuit, V_{T} was measured when an ac voltage was applied to a solenoid coil, which produced a magnetic field perpendicular to the plane of the SQUID. The maximum field was set at different levels to give B above and below B*.

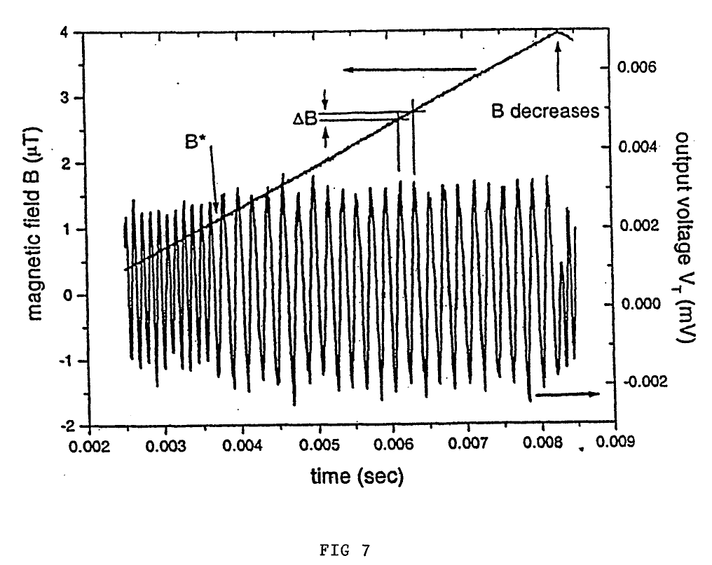

We define ΔB (periodicity) as the change in B which gives one flux quantum change of magnetic flux in the SQUID (i.e. Φ₀=ΔBA_{eff}). ΔB can be obtained by measuring the change of B in the B−t characteristic (t denotes time) when there is one periodic change of SQUID output voltage in the V_{T}−t characteristic. In accordance with the present invention, ΔB changes when B≧B* as shown in FIG. 7 for device 1. Devices 2 and 3 also show similar changes in periodicity, at different values of B*. It will be therefore be appreciated that, for a given SQUID device, B* may to some extent be controlled or selected by appropriate design of the device.

The effective areas A_{eff} of the SQUIDs at different values of ΔB were calculated from Φ₀/ΔB and are tabulated in Table I. The values of A_{eff} in regime II (B≧B*) are generally consistent with the values of A₁. In regime I (B<B*), the values of A_{eff} are around 25-30% smaller than the values of A₁+A₂L₁/L₂. The deviation is believed to be due to the fact that the actual magnetic field on the SQUID loop in regime I is smaller than the applied field B. This is because I₂ generates a magnetic field which is opposite to B in the SQUID loop.

We estimated the circulating current I₂ at which ΔB changes and compared I₂ with the critical current of the flux dam junction. From Ketchen et al., SQUID '85—Superconducting Quantum Interference Devices and their Applications, de Gruyter, Berlin, 1985, pp. 865-871, we know I₂≅4BDₚ/πμₒ. We define Iₑ as the value of I₂ when B=B*. For each device, Iₑ was calculated and tabulated in Table I. Iₑ has a value in the range of 0.5-1.3 mA which is consistent with the estimated value of the critical current (≅0.8 mA) of a 20 μm wide, 200 nm thick grain boundary junction using fabrication techniques such as those described in International Patent Application WO 00/16414.

From FIG. 7, it can be seen that the periodicity changes when the magnitude of B decreases. This behaviour can be explained in the following way. When B=B_{M}(B_{M}>B*) and decreases, the value of Φ₂ will follow the path MN (FIG. 6). Along MN, the flux dam will be closed (periodicity change) until B decreases to the value of B_{N} at which the flux dam will open. Therefore, Φ₂(B) has a hysteretic behaviour for any value B>B*.

Finally, it is noticed that there is an amplitude change in the V_{T}−t characteristic (FIG. 3) in the two regimes. This behaviour can be explained by the change of the mutual inductance in the two regimes. The depth of the voltage modulation is given by ΔV_{T}=ωL_{T}Φ₀/2M where M²=K²LL_{T} is the mutual inductance between the SQUID (L) and the tank circuit (L_{T}), K is the coupling coefficient and ω is the operating angular frequency. As L is different with and without the pick-up loop, the two regimes will give different values of M and hence a change of ΔV_{T} is expected.

As can be seen, fabrication of rf SQUIDs of different sizes with a flux dam in the pick-up loop causes a change of the effective area of the SQUID with varying applied flux, due to the flux dam being closed or opened. Further, the effective areas above and below B* are consistent with the expected theoretical values, allowing some design choice in causing the value of B* to be in a magnetic field range of interest. The value of the circulating current in the pick-up loop at which the flux dam opens is consistent with the flux dam critical current.

It is to be appreciated that although the present invention has been described with reference to particular embodiments, the present invention may be embodied in other forms. In particular, although rf SQUIDs have been described, the present invention is also applicable to dc SQUIDs.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method of measurement of absolute magnitude of a magnetic field, the method comprising the steps of:
providing a superconducting quantum interference device (SQUID) having an effective flux-collection area which varies with applied flux; and
determining an absolute magnitude of an applied magnetic field based on variations in said effective area.

2. The method of claim 1 wherein said step of determining comprises monitoring a periodicity of an output voltage waveform of the SQUID in order to determine when a variation in the effective flux-collection area has occurred.

3. The method of claim 1 wherein said step of determining comprises the steps of
recording a magnetic field value at which the effective flux-collection area alters; and
determining a change of the magnetic field from said magnetic field value.

4. The method of claim 1 wherein said step of providing comprises providing a flux dam in a pick up loop of the SQUID.

5. The method of claim 4 wherein said step of determining comprises:
calculating a critical value of applied magnetic field at which a current in the pick up loop is equal to a critical current of the flux-dam; and
determining that an applied magnetic field is equal to the calculated critical value when a periodicity of an output voltage of the SQUID changes.

6. The method of claim 4 wherein said flux dam is provided by forming a grain boundary in the material of the pick up loop, the grain boundary being formed over a step edge.

7. The method of claim 4, wherein said step of providing the flux dam comprises controlling formation of the flux dam such that a critical current of the flux dam arises when an applied magnetic field is in a range of interest.

8. The method of claim 7, wherein said flux dam is provided by forming a grain boundary in the material of the pick up loop, the grain boundary being formed over a step edge, and wherein formation of the flux dam is controlled by controlling a step height and a step angle of the step edge.

9. A superconducting quantum interference device for measurement of absolute magnitude of a magnetic field, the device having an effective flux-collection area which varies with applied flux.

10. The SQUID of claim 9, wherein the effective flux-collection area comprises a pick-up loop, and wherein a flux dam is provided in the pick up loop such that the effective area of the SQUID changes when a current in the pick up loop exceeds the critical current of the flux dam.

11. The SQUID of claim 10 wherein the critical current of the flux dam arises when an applied magnetic field is in a range of interest for an intended application of the SQUID.

12. The SQUID of claim 9, wherein the SQUID comprises a superconducting ring of HTS material interrupted by a Josephson Junction.

13. The SQUID of claim 12 wherein the Josephson Junction is implemented by formation of a grain boundary in the HTS material.

14. The SQUID of claim 13 wherein the Josephson Junction is formed over a step-edge in a substrate.

15. The SQUID of claim 13 wherein the Josephson Junction is formed by one of a microbridge, an ion-irradiated link, a superconductor-insulator-superconductor (SIS) junction, and a superconductor-normal metal-superconductor (SNS) junction.

16. The SQUID of claim 10 wherein the flux-dam is implemented by forming a grain boundary at a step edge in a substrate.

17. The SQUID of claim 10 wherein the flux dam is implemented by use of a microbridge.

18. The SQUID of claim 9 wherein the SQUID is an rf-SQUID.

19. The SQUID of claim 9 wherein the SQUID is a dc-SQUID.

20. A method of measurement of absolute value of a magnetic field, the method comprising the steps of:
providing a pick-up loop for a SQUID, the pick-up loop having a flux dam having a critical current, the critical current occurring in the pick-up loop when a critical magnetic field is applied to the SQUID; and
determining an absolute value of an applied magnetic field by comparison to said critical magnetic field.

21. The method of claim 20 further comprising the step of fabricating the flux-dam such that the critical magnetic field is in a magnetic field range of interest.

22. The method of claim 21, wherein the flux dam is fabricated by forming a grain boundary in the material of the pick-up loop, the grain boundary being formed over a step edge in a substrate.

23. The method of claim 21 wherein the flux dam is fabricated by forming by a microbridge.

24. A pick-up loop for a SQUID for measurement of absolute value of a magnetic field, the pick-up loop having a flux dam having a critical current, the critical current arising when a critical magnetic field is applied to the SQUID, and the flux dam being formed such that the critical magnetic field is in a magnetic field range of interest.

25. The pick-up loop of claim 24, wherein the flux dam comprises a grain boundary formed over a step edge in a substrate.

26. The pick up loop of claim 25, wherein an angle and height of the step edge serve to control the critical current of the flux dam to be in the magnetic field range of interest.

27. The pick-up loop of claim 24 wherein the flux dam comprises a microbridge.
